(19) United States
(12) Patent Application Publication
(10) Pub. No.: US 2024/0046004 A1
(43) Pub. Date: Feb. 8, 2024

(54) COMPUTER-IMPLEMENTED METHOD, COMPUTER SYSTEM AND COMPUTER PROGRAM FOR DESIGNING A LOGISTICS LOAD CARRIER

(71) Applicant: Conrevor INTERNATIONAL NV, Merelbeke (BE)

(72) Inventor: Bart Vermeulen, Merelbeke (BE)

(21) Appl. No.: 17/816,907

(22) Filed: Aug. 2, 2022

(51) Int. Cl. G06F 30/20; G06F 30/15

(52) U.S. Cl. CPC G06F 30/20; G06F 30/15; G06F 2111/04

(57) ABSTRACT

Computer implemented methods for design of a logistics carrier (LC) comprising: determining an available interior space for the LC; selecting a model of a first element of the LC (first element is a type of frame); selecting a model of a second element of the LC, (second element is a type of classification element); adding a 3D model of a third element of the LC, (third element is a component to be transported) and where the 3D model includes the dimensions of the component; determining dimensions of the frame and a layout element; optimizing an arrangement of the components in the layout element to maximize a number of the components in the LC, with the components positioned within the layout element; and, generating a 3D model of the designed LC.

### TECHNICAL FIELD

The invention relates to a computer-implemented method for designing a logistics load carrier.

In a second aspect, the invention also relates to a computer system for carrying out a computer-implemented method according to the first aspect.

In a third aspect, the invention also relates to a computer program for carrying out a computer-implemented method according to the first aspect.

### BACKGROUND

In large assembly industries, such as the automotive industry and the white goods sector, customized logistics carrying devices are widely used. Assembly industries produce the same product on a large scale for years and need adapted logistics load carriers to bring parts from the suppliers to the assembly line. Standard logistics load carriers, such as a pallet or a container, are not necessarily optimal in terms of dimensions and are also not designed to keep the parts free of damage during storage and transport.

It is important with a tailor-made logistics load carrier that logistics costs over the period of use are limited as much as possible. This is mainly achieved by a high density of parts in the logistics load carrier and reuse of logistics load carriers or parts of logistics load carriers for the transport of other components after an initial period of use of the logistics load carrier. In addition to density, ergonomics of the logistics load carrier is an important aspect, especially if heavy parts are transported in the logistics load carrier. Technical features of the parts, such as the weight, must also be taken into account when designing the tailor-made logistics load carrier. Finally, parts are sometimes only fully defined shortly before the start-up of assembly, so that a design of a tailor-made logistics load carrier must be done quickly.

Today, such tailor-made logistics load carriers are designed in a CAD system by a technically highly qualified designer. The designer is under high time pressure and determines their design based on their own experience with a limited number of previous designs. The designer determines a grid-shaped layout element for the logistics load carrier. This is disadvantageous because the grid-shaped layout element does not necessarily result in an optimal arrangement with a high density of parts. It is additionally disadvantageous that if the number of parts that can be transported by the logistics load carrier is insufficient, the designer must change the dimensions of the layout element, after which the design of the logistics load carrier itself must most likely also be adapted. This involves many time-consuming actions for the designer in the CAD system.

Based on the knowledge gained, the designer chooses materials and dimensions for the logistics load carrier and the grid-shaped layout element so that they are strong enough for the number of parts to be transported. However, these are co-determined by the number of parts in the logistics load carrier, which is only known after the grid-shaped element is designed. It is therefore possible that after designing the grid-shaped element, dimensions of the logistics load carrier and/or the grid-shaped element have to be adjusted again, which again leads to time-consuming changes. By default, this is compensated by providing sufficiently large margins for an initial starting point for the design of the logistics load carrier and its layout element, as a result of which once again an optimal arrangement with high density of parts is not achieved.

The aim of the invention is to provide a method which eliminates those disadvantages.

### SUMMARY OF THE INVENTION

In a first aspect, the present invention relates to a computer-implemented method for designing a logistics load carrier comprising the following steps: determining an available interior space for the logistics load carrier; selecting a model of a first element of the logistics load carrier, wherein the first element is a type of frame; selecting a model of a second element of the logistics load carrier, wherein the second element is a type of a layout element; adding a 3D model of a third element of the logistics load carrier, wherein the third element is a component to be transported and wherein the 3D model comprises the dimensions of the component; determining dimensions of the frame and the layout element; optimizing an arrangement of the components in the layout element to maximize the number of components in the logistics load carrier, wherein the components are positioned within the layout element; and, generating a 3D model of the designed logistics load carrier; wherein the available interior space is a constraint for determining the dimensions of the frame and the layout element, wherein the available interior space falls within the dimensions of the frame, and wherein the dimensions of the layout element fall within the available space.

The method comprises selecting a model of a first and a second element. The first element is the frame, and the second element is the layout element of the logistics load carrier to be designed. A model of a third element, the part to be transported, is also added to the method. The dimensions of the frame and the layout element are determined and the arrangement of the parts within the layout element is optimized. In this process, many possible arrangements of parts are tested, in order to arrive at an optimal arrangement with a high density of parts. The great advantage of the current method compared to the prior art is that an available interior space is determined, wherein the available interior space is a constraint for determining the dimensions of the frame and the layout element, wherein the available interior space falls within the dimensions of the frame and wherein the dimensions of the layout element fall within the available space. By using the available interior space as a constraint, it is avoided that, when optimizing the arrangement of the parts, dimensions of the layout element or the frame are changed in such a way that it is also necessary to adapt dimensions of the frame or the layout element, respectively, as a result of which, in turn, the arrangement may have to be optimized again. As a result, an optimal arrangement with high density of parts is quickly achieved.

A particular preferred embodiment of the invention relates to a computer-implemented method wherein dimensions of the frame and/or the layout element are defined as a constraint. According to this embodiment, it is possible to define dimensions of the first or second element as a constraint. This is particularly advantageous if a part of an existing logistics load carrier, such as a frame, is reused. As a result, not only can an optimal arrangement with high density of parts be obtained quickly, but also a cost-efficient logistics load carrier.

In a second aspect, the present invention relates to a computer system that has the advantage that it is configured to perform a method according to the first aspect.

### DETAILED DESCRIPTION

Unless otherwise defined, all terms used in the description of the invention, including technical and scientific terms, have the meaning generally understood by those skilled in the technical field of the invention. For a better understanding of the description of the invention, the following terms are explained explicitly.

In this document, “a” and “the” refer to both the singular and the plural, unless the context presupposes otherwise. For example, “a segment” means one or more segments.

The terms “comprise,” “comprising,” “consist of,” “consisting of” “provided with,” “include,” “including,” “contain”, “containing”, are synonyms and are inclusive or open terms that indicate the presence of what follows, and which do not exclude or prevent the presence of other components, characteristics, elements, members, steps, as known from or disclosed in the prior art.

In the context of this document, “logistics load carriers” are means to collect goods for transportation, storage, packaging, shipping, and product protection in a supply chain and which are returned for further use, such as, for example, all forms of reusable crates, racks, boxes, roll containers, etc.

In the context of this document, “CRM” refers to a software package for Customer Relationship Management. This includes managing customer data and interactions with customers.

In the context of this document, “PLM” refers to a software package for Product Lifecycle Management. The software package supports the management of the entire life of a product, from the starting point, through development and manufacture, to service and removal of the product.

In the context of this document, “ERP” refers to a software package for Enterprise Resource Planning. The software package supports all processes within a company within said company. The software package typically comprises several modules, all of which support a specific task. Examples are stock management, business administration, logistics, etc.

In the context of this document, “CAD” refers to a software package for Computer-Aided Design. The software package supports a designer in creating, modifying, analyzing, and optimizing a design. The software package preferably supports drawing figures and curves in two dimensions as well as drawing curves, surfaces, and volumes in three dimensions.

In a first aspect, the invention relates to a computer-implemented method for designing a logistics load carrier.

In a preferred embodiment, the computer-implemented method comprises the steps of determining an available interior space for the logistics load carrier, selecting a model of a first element of the logistics load carrier, selecting a model of a second element of de logistics load carrier, adding a 3D model of a third element of the logistics load carrier, determining dimensions of the first and second element, optimizing an arrangement of the third elements and generating a 3D model of the designed logistics load carrier.

A logistics load carrier comprises a frame and preferably a layout element.

The frame is an element that gives the logistics load carrier structural strength. The frame comprises a floor, walls, and a ceiling. The floor, the walls and the ceiling define a load volume. Optionally, the frame comprises means for attaching a layout element.

The frame may be a closed frame, wherein the floor, walls and ceiling are solid, closed surfaces.

The frame may be an open frame. An open frame comprises horizontal and vertical frame members. A first group of horizontal frame members forms a rectangular open floor of the frame, and a second group of horizontal frame members forms a rectangular open ceiling of the transport frame. Vertical frame members connect the horizontal frame members of the floor to the horizontal frame members of the ceiling. A horizontal frame member of the floor, a horizontal frame member of the ceiling and connecting vertical frame members between said horizontal frame member of the floor and said horizontal frame member of the ceiling form an open wall of the transport frame.

The frame may be a half-open or half-closed frame, wherein the frame comprises at least one open surface and at least one closed surface.

The first element of the logistics load carrier is a type of frame. A frame type is selected by the designer based on identified requirements for the logistics load carrier. Non-limiting examples of requirements are foldability of the logistics load carrier, mobility of the logistics load carrier, stackability of the logistics load carrier, etc. Non-limiting examples of frame types include crates, racks, roll containers, etc.

The layout element is an element that forms a compartmentalization of the load volume of the logistics load carrier. The layout element can form a horizontal compartmentalization. The layout element can form a vertical compartmentalization. The layout element can form a diagonal compartmentalization. The layout element can form a compartmentalization, wherein shapes of the compartmentalization correspond to shapes of components to be transported. The layout element can form a compartmentalization which is a combination of each of the previous compartmentalizations or another suitable shape. Optionally, the layout element comprises means for attaching the layout element to the frame.

The second element of the logistics load carrier is a type of layout element. A layout element type is selected by the designer based on identified requirements for the logistics load carrier. Non-limiting examples of requirements are collapsibility of the logistics load carrier, weight of components to be transported, orientation of components to be transported, resistance to grease, etc. Non-limiting examples of layout element types are layout elements formed from textiles, with or without reinforcing parts, layout elements formed with shelves, foam rubber layout elements in which shapes are hollowed out in the foam rubber layout elements to match components to be transported, a latticework system as layout element, etc.

The model of the first or second element of the logistics load carrier comprises a description of the first and second model, respectively, in a computer program readable and interpretable language. The description comprises at least the form of the first or the second element, respectively. The description preferably comprises three orthogonal reference axes. The model describes two-dimensional views of the shape. The two-dimensional views are preferably a projection according to one of the three aforementioned reference axes. Preferably, there is at least one view per reference axis. Preferably, the model comprises a three-dimensional description of the shape. Preferably, the model comprises dimensions of the shape. Preferably, the model is parameterizable. A non-limiting example is a model of a second element that describes a latticework system with boxes in rows and columns, wherein a first parameter determines the number of rows, a second parameter a number of columns, a third parameter the height of a box and a fourth parameter the width of a box. Preferably, the model is readable by a CAD system. Optionally, the model includes metadata. Non-limiting examples of metadata are materials, weights, colors, etc.

The third element of the logistics load carrier is a component to be transported. The third element is not a functional part of the logistics load carrier and strictly speaking does not belong to the logistics load carrier. The third element is not a result of the design of the logistics load carrier. A model of the third element is added by the designer to the method as additional information for optimization of the design of the logistics load carrier. The model is similar to the models of the first and the second element described above. The model is a three-dimensional (3D) model. The model comprises the dimensions of the component to be transported. This is necessary since the dimensions of the component to be transported are a given for performing the computer-implemented method. It will be apparent to one skilled in the art that if different types of third elements have to be stored and transported in a logistics load carrier, a three-dimensional model will be added for each type of third element.

The available interior space is a volume within the load volume of the frame that is available for transporting components. The available interior space is therefore at most equal to the load volume. The available interior space is occupied by both the second element and the components to be transported. It will be apparent to one skilled in the art that the available space does not necessarily have to be, nor can it be, fully occupied by the second element and the components to be transported.

The available interior space is determined by the designer and entered in the computer-implemented method.

Based on the available interior space, the dimensions of the frame and the layout element are determined by the designer. Preferably, only external dimensions of the layout element are determined by the designer. Dimensions within the layout element are preferably determined automatically during the optimization of the arrangement of the components to be transported. A non-limiting example is determining the number of rows and columns and the height and width of a box in a latticework system with boxes in rows and columns. The available interior space is a constraint when determining the dimensions. The available interior space falls within the dimensions of the frame. The available interior space therefore fits within the load volume. The dimensions of the layout element fall within the available space. The computer-implemented method does not allow a frame where the load volume is smaller than the available interior space. The computer-implemented method does not allow a layout element in which the dimensions of the layout element do not fall within the available space. This constraint is checked automatically by the computer-implemented method. This is advantageous because it avoids that a designer determines dimensions for a frame or a layout element, which are not compatible with each other, and time-consuming design steps have to be carried out unnecessarily again. As a result, a logistics load carrier can be designed more quickly. For any means comprised in a frame for attaching a layout element or means comprised in a layout element for attaching the layout element to a frame, the available interior space is not a constraint for the dimensions of said means, so that said means can effectively extend from a frame to a layout element.

During the optimization of the arrangement of the components to be transported, several options are automatically tested. The aim of the optimization is to maximize the density of components to be transported. When testing the options, the constraint of the available interior space is taken into account. A non-limiting example is a latticework system with boxes in rows and columns, wherein the number of rows and columns, the height and the width of a box is determined in such a way that external dimensions of the latticework system fall within the available space. By using the available interior space as a constraint, it is avoided that, when optimizing the arrangement of the components, dimensions of the layout element are changed in such a way that it is also necessary to adapt dimensions of the frame, as a result of which time-consuming design steps have to be carried out again unnecessarily. During the optimization, components are automatically translated along and rotated around three orthogonal reference axes. These three orthogonal reference axes are connected to the logistics load carrier and are not necessarily the same as, or oriented the same as, the three orthogonal reference axes in the model of the first, second and/or third element. Each individual component can be differently translated and rotated along and around the three orthogonal reference axes of the logistics load carrier. Preferably, each individual component can also be translated and/or rotated along and around the three orthogonal reference axes of the model of a third element. The optimization has the additional constraint that the components are positioned within the layout element.

In a final step of the computer-implemented method, a three-dimensional (3D) model of the designed logistics carrier is automatically generated. The model is similar to the models of the first, second and third elements described above. Preferably, the model comprises metadata. Non-limiting examples of metadata are materials, weights, colors, etc. of preferably both the first and the second element. Optionally, the model also comprises a description of the components to be transported.

In one embodiment, the models of the first, second and third elements are saved in .DWG format. This is advantageous because the .DWG format is supported by many CAD systems.

In one embodiment, at least the 3D model of the designed logistics carrier, the selected model of the first and second element and the added model of the third element are added in a PLM system. Requirements that the designed logistics carrier meets are preferably also stored in the PLM system. This is advantageous for later reference in future designs.

In one embodiment, the model of the first element and the model of the second element are selected from a library of models. This is advantageous because a designer has all possible previously designed frames and/or layout elements at their disposal and can reuse frames and/or layout elements from previously designed logistics load carriers in the design of a logistics load carrier.

In one embodiment, a first and/or a second element are automatically selected based on requirements for the logistics load carrier. This is advantageous because a designer comes to a suitable selection faster than with a complete manual selection from all possible types of frames and layout elements. The designer enters requirements for the logistics load carrier in the computer-implemented method. This can be entered in the form of text fields, selection menus or another suitable form in a computer program. A selection of suitable first and/or second elements is automatically made. If several types of frames and/or layout elements meet the requirements, these are presented to the designer, after which they make a final selection. Preferably, a preferred choice for selection is presented to the designer. If both a frame and a layout element must be selected by the designer, these are preferably suggested as pairs. This is advantageous because it ensures that a combination of a selected frame and a selected layout element meets the entered requirements.

In one embodiment, when adding the 3D model of the third element, additional metadata is entered. Non-limiting examples of metadata are weight, material, color, surface treatments of the component, scratch sensitivity, etc. The metadata can optionally be integrated into the 3D model. The metadata is used as a constraint when selecting the first and second element. For example, for a component with a high scratch sensitivity, only layout elements with a soft surface will be selected, or for a component that is lubricated with grease, a layout element that is resistant to the grease will be selected, or only frames and layout elements that can support the weight of the components will be selected. This embodiment is advantageous in that certain requirements can thereby be automatically checked, whereby a suitable design of the logistics load carrier is achieved more quickly and whereby a designer is less likely to make design errors.

In one embodiment, the dimensions of the frame are automatically determined based on the defined available space. The dimensions of the frame are automatically adjusted so that minimum dimensions for the frame are obtained, wherein the constraint imposed by the available space is still respected. A parameterizable model of the first element is particularly advantageous in this embodiment because the dimensions of a frame can be changed automatically by changing parameters that determine the dimensions of the frame. This embodiment is advantageous for rapid design of a logistics load carrier in that a designer does not have to manually determine the dimensions of the selected frame type.

In one embodiment, the dimensions of the layout element are automatically determined based on the defined available space. Preferably, only external dimensions of the layout element are determined automatically on the basis of the defined available space. The dimensions of the layout element are automatically adjusted so that maximum dimensions for the layout element are obtained, wherein the constraint imposed by the available space is still respected. Similar to an embodiment described above, a parameterizable model for the second element is particularly advantageous. This embodiment provides similar advantages as a previous embodiment.

According to an embodiment, dimensions of the frame and/or the layout element can be defined as a constraint. This means that one or more dimensions of a frame and/or a layout element are defined. During determination of the dimensions of the frame and/or the layout element, respectively, or during optimization of the arrangement of the components in the layout element during subsequent steps of the computer-implemented method, said dimensions of the frame and/or the layout element, respectively, cannot be changed. Defining a dimension as constraint can be done as a separate input in the method or by selecting a model of a first and/or a second element, wherein the dimensions of the frame or the layout element are fixed in the model of the element itself. This embodiment is particularly advantageous in the event that a part of an existing logistics load carrier, such as a frame, is reused. As a result, not only can an optimal arrangement with high density of parts be obtained quickly, but also a cost-efficient logistics load carrier.

In one embodiment, a model of a first, a second, and a third element can be selected, added, and/or changed in any order. This is advantageous because it gives the computer-implemented method flexibility, for example if there is a preference for a type of layout element, by first selecting a layout element and then selecting a frame that, together with the layout element, can meet the requirements for the logistics load carrier. Continuing with the same example, it is also advantageous, for example, to still change the layout element again if no combinations of a frame and the selected type of layout element meet the requirements for the logistics load carrier, or if a suitable frame is preferably not selected for other reasons. This is particularly advantageous in combination with a previously described embodiment in which a model of a first and/or a second element is automatically selected on the basis of requirements for the logistics load carrier. By selecting a model for the first element, for example, only suitable second elements can be selected automatically. By changing the selection of a model for the second element, the designer can quickly evaluate various suitable designs for the logistics load carrier.

In one embodiment, there is a default value for the available interior space. The default value is preferably a frequently used value for the available interior space. This is advantageous because it allows the designer to optionally skip this step in the computer-implemented method. The available interior space can still be determined by the designer, so the default value is not used.

In one embodiment, the available interior space is automatically determined based on dimensions of the frame. The available space is at most equal to the load volume. This embodiment is particularly advantageous in combination with a previously described embodiment in which dimensions of a frame are defined as a constraint. This embodiment is advantageous because it allows a step in the method to be skipped by the designer. An additional advantage is that the designer cannot define any available space that is not complementary to the dimensions of the frame that are defined as a constraint. Preferably, an already determined available interior space is overwritten by the automatically determined available interior space. A confirmation for this action is preferably requested from the designer. Preferably, this embodiment is in combination with an embodiment described above in which there is a default value for the available space.

According to an embodiment, the available interior space is automatically determined based on dimensions of the layout element. The available interior space is at least equal to the external dimensions of the layout element. This embodiment is particularly advantageous in combination with a previously described embodiment in which dimensions of a layout element are defined as a constraint. The advantages are similar to an embodiment described above in which the available interior space is determined automatically on the basis of dimensions of the frame.

In one embodiment, upon changing the available interior space, by changing the dimensions of the frame or the layout element, the dimensions of the layout element or the frame, respectively, automatically changes. This embodiment is particularly advantageous in combination with previously described embodiments in which the available interior space is automatically determined on the basis of dimensions of the frame or the layout element. This guarantees that the frame and the layout element are always compliant with the constraint imposed by the available interior space, without additional design steps being required by the designer.

In one embodiment the different steps of the method can be repeated. This is advantageous because it allows a modified design for a logistics load carrier to be obtained quickly, for example after additional requirements for the logistics load carrier have been defined during its design.

In one embodiment one or more constraints can be imposed on the optimization of the arrangement of the components. A non-limiting example of a constraint is the orientation of the components. This is advantageous, for example, if the components have to be arranged according to a specific orientation in order to remove them from the logistics load carrier in an ergonomic manner. This is also advantageous if the components have to be loaded and unloaded from a logistics load carrier on a certain side. This constraint can be entered separately or included as metadata in the model of the third element. Another non-limiting example is the total number of components. This is advantageous if a frame and/or layout element can bear a maximum weight that may not be exceeded. This constraint can be entered separately or included as metadata in the model of the first and/or second element, respectively.

In one embodiment, during optimization of the arrangement of the components, the dimensions of the frame are automatically adjusted. This is particularly advantageous if an arrangement with a number of components is obtained during optimization, wherein the combined weight of the components is greater than the maximum weight the frame can support. The dimensions of the frame will be automatically adjusted until the frame can support the weight. By using the available interior space as constraint, it is avoided that the dimensions of the frame are changed in such a way that it is also necessary to adjust the dimensions of the layout element, which in turn may require the arrangement to be optimized again. As a result, an optimal arrangement with high density of components is quickly obtained, without unnecessary design steps.

In one embodiment, the computer-implemented method comprises using parameterizable models for the first and/or the second element. The range of parameters is automatically limited, so that no parameters can be used when determining the dimensions of the frame and/or the layout element, respectively, as a result of which the constraint of the available space would not be respected.

In one embodiment, the optimization of the arrangement of the components in the layout element comprises a stop condition when a minimum number of components is reached or exceeded. Alternatively, the stop condition is a minimum percentage of the available interior space that is taken up by the components. Preferably, there is a stop condition when a maximum number of tests of arrangements is reached. This last stop condition is advantageous to avoid that the optimization is carried out endlessly.

In one embodiment, two-dimensional (2D) detail drawings are generated based on the 3D model of the designed logistics load carrier. The 2D detail drawings are advantageous for a rapid transfer of a designed logistics load carrier to a production unit for production of the logistics load carrier. Preferably, the 2D detail drawings of a final design are automatically forwarded to a customer. The customer can approve the final design of the logistics load carrier based on the 2D detail drawings. The automated forwarding of the 2D detail drawings of the final design prevents incorrect information from previous designs from being delivered to the customer. Contact details of the customer are preferably retrieved automatically from a CRM system. Optionally, additional information, such as, for example, but not limited to a specification and a 3D model, of the designed logistics load carrier can also be sent along.

In one embodiment, the 3D model of the designed logistics load carrier is displayed in augmented reality. Augmented reality allows a designer and/or a customer to evaluate the designed logistics load carrier virtually in an assembly industry. It can thus be verified that the designed logistics load carrier meets the set requirements. If necessary, the designed logistics load carrier can be quickly adjusted based on the feedback from the evaluation in the virtual environment. This is particularly advantageous for feedback related to ergonomic requirements, as ergonomic deficiencies are usually only identified during first use, which can lead to costly adjustments to a logistics load carrier and, in the worst case, to a completely new design.

In one embodiment, a cost calculation is made of the designed logistics load carrier. The cost calculation is based on data available in an ERP system and BOMs for the designed logistics load carrier that are automatically determined on the basis of the 3D model. Preferably, the data is retrieved automatically from the ERP system. Preferably, the cost calculation is an automated process. Cost calculations are labor-intensive and can only be done after the final design of a logistics load carrier. By integrating the cost calculation into the computer-implemented method according to the present invention, the designer quickly has information about the cost of the designed logistics load carrier. If the cost does not meet the requirements of the logistics load carrier, the design can be adjusted at an early stage. As a result, a cost-effective logistics load carrier is achieved more quickly.

In one embodiment, an intermediate result of each step of the method is automatically visualized. This is advantageous because a designer receives continuous visual feedback about the logistics load carrier to be designed. The intermediate results can also be quickly and easily shown to a customer, so that the design can be adjusted by the customer during intermediate steps.

In one embodiment, on the basis of all previous designs of logistics load carriers and after adding a 3D model of the third element, all other steps of the computer-implemented method are automatically carried out. Using artificial intelligence, the 3D model of the third element is compared with 3D models of third elements that were stored together with the previous designs, for example in a PLM system. A previous design of a logistics load carrier whose 3D model of a third element best corresponds to the added 3D model of the third element will be selected as the starting position, wherein the first element, the second element and optionally the dimensions of the frame, the dimensions of the layout element, the available interior space, and the arrangement of the components in the layout element are used. The dimensions are then determined and the arrangement of the components in the layout element is optimized. Using the arrangement of the components in the layout element is a good starting position for rapid optimization. This embodiment is advantageous because a technically highly qualified designer is not necessarily required to design a logistics load carrier. Preferably, when comparing the 3D model of the third element with 3D models of third elements that were stored together with the previous designs, requirements for the logistics load carrier to be designed and requirements that the previous designs meet shall also be taken into account.

It will be apparent to one skilled in the art that one or more of the previously described embodiments of the computer-implemented method can be combined advantageously.

In a second aspect, the invention relates to a computer system for carrying out a computer-implemented method according to the first aspect. The computer system comprises a processor suitable for executing instructions, a permanent memory readable by the computer system for storing instructions and a non-permanent working memory accessible to the computer system. Preferably, the computer system comprises a network interface.

In one embodiment, the computer system is connected to a second computer system via a network. The second computer system is configured as an interface for a user to perform the method on the computer system according to the present invention. The second computer system is a personal computer, a thin client, or a tablet. This embodiment is advantageous for performing the computer-implemented method on the move, e.g. in an assembly industry environment, allowing a designer to design a logistics load carrier in direct collaboration with a customer.

In one embodiment, the computer system is linked to a CRM system. The computer system is preferably connected to the CRM system via a network. This embodiment is particularly advantageous in combination with a previously described embodiment in which the 2D detail drawings of a final design are forwarded to a customer in an automated manner. The contact details of a customer can be retrieved automatically from the CRM system and the CRM system can be used to automatically book when and to which contact persons at the customer the 2D detail drawings were forwarded.

In one embodiment, the computer system is linked to a PLM system. The computer system is preferably connected to the PLM system via a network. This embodiment is advantageous for storing a designed logistics load carrier, preferably in combination with selected models of the first and second elements, the added model for the third element and the requirements that the logistics load carrier meets.

In one embodiment, the computer system is linked to an ERP system. The computer system is preferably connected to the ERP system via a network. This embodiment is advantageous for the automated execution of a cost calculation on the basis of BOMs derived from the 3D model of the designed logistics load carrier and on the basis of data available in the ERP system, such as, for example, but not limited to material costs, processing costs and labor costs.

In one embodiment, the computer system is linked to an CAD system. The computer system is preferably connected to the CAD system via a network. This embodiment is advantageous for providing a library of models of first and second elements designed in the CAD system.

In a third aspect, the invention relates to a computer program comprising instructions which, when executed by a computer, executes a computer-implemented method according to the first aspect.

1. A computer-implemented method for designing a logistics load carrier comprising the following steps:
determining an available interior space for the logistics load carrier;
selecting a model of a first element of the logistics load carrier, wherein the first element is a type of frame;
selecting a model of a second element of the logistics load carrier, wherein the second element is a type of a layout element;
adding a 3D model of a third element of the logistics load carrier, wherein the third element is a component to be transported and wherein the 3D model comprises the dimensions of the component;
determining dimensions of the frame and the layout element;
optimizing an arrangement of the components in the layout element to maximize the number of components in the logistics load carrier, wherein the components are positioned within the layout element; and,
generating a 3D model of the designed logistics load carrier;
wherein the available interior space is a constraint for determining the dimensions of the frame and the layout element, wherein the available interior space falls within the dimensions of the frame, and wherein the dimensions of the layout element fall within the available space.

2. The computer-implemented method according to claim 1, wherein a model of a first, a second and a third element is selected, added and/or changed in any order.

3. The computer-implemented method according to claim 1, wherein dimensions of the frame and/or the layout element are defined as a constraint.

4. The computer-implemented method according to claim 1, wherein after changing the available interior space due to a change in the dimensions of the frame or the layout element, the dimensions of the layout element or the frame, respectively, change automatically.

5. The computer-implemented method according to claim 1, wherein the different steps of the method are repeated.

6. The computer-implemented method according to claim 1, wherein, based on the 3D model of the designed logistics load carrier, 2D detail drawings are generated.

7. The computer-implemented method according to claim 1, wherein the 3D model of the designed logistics carrier is displayed in augmented reality.

8. The computer-implemented method according to claim 1, wherein one or more constraints, such as an orientation of the components, is imposed on the optimization of the arrangement of the components.

9. The computer-implemented method according to claim 1, wherein a cost calculation of the designed logistics load carrier is made.

10. The computer-implemented method according to claim 1, wherein when adding the 3D model of the third element, additional metadata is entered, which is used as a constraint when selecting the first and second element.

11. The computer-implemented method according to claim 1, wherein the model of the first and the second element is selected from a library of models.

12. The computer-implemented method according to claim 1, wherein an intermediate result of each step of the method is automatically visualized.

13. The computer-implemented method according to claim 1, wherein based on previous designs of logistics load carriers and after adding the 3D model of the third element, all other steps of the method are automatically carried out.

14. A computer system for carrying out the computer-implemented method according to claim 1.

15. The computer system of claim 14, wherein the computer system is linked to a CRM system.

16. The computer system according to claim 14, wherein the computer system is linked to a PLM system.

17. The computer system according to claim 14, wherein the computer system is linked to an ERP system.

18. The computer system according to claim 14, wherein the computer system is linked to an CAD system.

19. A computer program comprising instructions that, when executed by a computer, performs the computer-implemented method according to claim 1.

20. The computer-implemented method according to claim 1, wherein the layout is a compartmentalization of the available interior space, and wherein forms of the compartmentalization match forms of the components.
